(19) United States
(12) Patent Application Publication
(10) Pub. No.: US 2011/0255689 A1
(43) Pub. Date: Oct. 20, 2011

(54) MULTIPLE-MODE CRYPTOGRAPHIC MODULE USABLE WITH MEMORY CONTROLLERS

(75) Inventors: Anatoli Bolotov, Cupertino, CA (US); Mikhail I. Grinchuk, San Jose, CA (US); Timothy E. Hoglund, Colorado Springs, CO (US); Lav D. Ivanovic, Sunnyvale, CA (US); Paul G. Filseth, Los Gatos, CA (US)

(73) Assignee: LSI CORPORATION, Milpitas, CA (US)

(21) Appl. No.: 12/761,024

(22) Filed: Apr. 15, 2010

(51) Int. Cl. H04L 9/18

(52) U.S. Cl. 380/42

(57) ABSTRACT

In one embodiment, a multi-mode Advanced Encryption Standard (MM-AES) module for a storage controller is adapted to perform interleaved processing of multiple data streams, i.e., concurrently encrypt and/or decrypt string-data blocks from multiple data streams using, for each data stream, a corresponding cipher mode that is any one of a plurality of AES cipher modes. The MM-AES module receives a string-data block with (a) a corresponding key identifier that identifies the corresponding module-cached key and (b) a corresponding control command that indicates to the MM-AES module what AES-mode-related processing steps to perform on the data block. The MM-AES module generates, updates, and caches masks to preserve inter-block information and allow the interleaved processing. The MM-AES module uses an unrolled and pipelined architecture where each processed data block moves through its processing pipeline in step with correspondingly moving key, auxiliary data, and instructions in parallel pipelines.

### BACKGROUND OF THE INVENTION

1. Field of the Invention

The current invention relates to cryptography, and in particular to modules for the encryption of plaintext and/or decryption of ciphertext.

2. Description of the Related Art

Encryption and decryption are cryptographic processes that convert plaintext into ciphertext and vice versa, respectively. Plaintext refers to text-based data (i.e., a sequence of bit strings) that is typically readily readable by and comprehensible to a human. Note that, more generally, plaintext refers to the input to an encryption algorithm, and the plaintext may well be gibberish. Data encryption is a process used to convert a block of plaintext into a block of ciphertext, where ciphertext typically appears to be gibberish not readily readable by or comprehensible to a human. Note that, more generally, ciphertext refers to the output of an encryption algorithm, and the ciphertext might happen to resemble recognizable text. A typical flow of information in cryptography involves inputting original plaintext into an encryption algorithm that outputs ciphertext, transmitting the ciphertext, and then inputting the ciphertext into a complementary decryption algorithm that outputs the original plaintext.

One way to encrypt plaintext involves using a key. The resulting ciphertext is decrypted using the appropriate corresponding key. A cryptographic system that uses the same key for both encryption and decryption is known as a symmetric cryptographic system. A collection of functions and their inverses that use keys and map strings of a fixed length to strings of the same length is known as a block cipher. One popular symmetric block cipher is the Advanced Encryption Standard (AES), described in Federal Information Processing Standards Publication (FIPS) 197, incorporated herein by reference in its entirety. Older FIPS-approved symmetric block ciphers include the Data Encryption Standard (DES) and triple-DES.

Symmetric block ciphers are used in multiple endeavors and for multiple purposes. One use for symmetric block ciphers is for the cryptographic protection of data on block-oriented storage devices, such as typical computer hard drives. Two typical characteristics of storage-device data protection transforms are that they (1) are length-preserving, meaning a block of ciphertext is the same length as the corresponding block of plaintext and (2) allow for independent processing of data units.

A symmetric block cipher, such as AES, may be used in a variety of operational modes, each involving a different way of using the block cipher. Several operational modes are useful for avoiding having identical outputs from identical inputs into a cryptographic algorithm. Since having identical outputs from identical inputs can be used by an adversary to break a cryptographic algorithm, it can be useful to have operational modes that, given an input stream including identical blocks A₀, A₁, . . . , A_{g}, (in other words, A₀=A₁=A_{g}), output corresponding but non-identical output blocks B₀, B₁, . . . , B_{g} (in other words, B₀≠B₁≠B_{g}), respectively.

Several basic modes are described in the National Institute of Standards and Technology (NIST) Special Publication (SP) 800-38A, titled “Recommendation for Block Cipher Modes of Operation,” and incorporated herein by reference in its entirety. An additional mode of operation is described in NIST Special Publication 800-38D, titled “Recommendation for Block Cipher Modes of Operation: Galois/Counter Mode (GCM) and GMAC,” incorporated herein by reference in its entirety. Yet another mode of operation, LRW (named for Liskov, Rivest, and Wagner), is described in the IEEE's 2006 P1619D5 publication, titled “Draft Standard Architecture for Encrypted Shared Storage Media,” incorporated herein by referenced in its entirety.

A further additional mode of operation, XTS (XEX-based Tweaked codebook mode with ciphertext Stealing, where “XEX” is from “XOR-Encrypt-XOR”), is described in IEEE's Std 1619-2007 publication, titled “IEEE Standard for Cryptographic Protection of Data on Block-Oriented Storage Devices,” incorporated herein by reference in its entirety, which describes one system for storage-device data protection. The XTS mode is also described in NIST Special Publication Draft 800-38E, titled “Recommendation for Block Cipher Modes of Operation: The XTS-AES Mode for Confidentiality on Block-Oriented Storage Devices,” incorporated herein by reference in its entirety.

Yet another mode of operation, which combines counter (CTR) mode encryption with Cipher Block Chaining Message Authentication Code (CBC-MAC), is the Counter with CBC-MAC (CCM) mode. CCM mode is described in the Internet Engineering Task Force's (IETF's) request for comment (RFC) 3610, incorporated herein by reference in its entirety. The various modes use the plaintext, input vectors, and cipher functions in a variety of ways, described in more detail below.

Each of the various modes described below uses a cryptographic kernel executing an underlying block-cipher algorithm that is assumed to be a FIPS-approved symmetric-key block-cipher algorithm where a secret, random key K has been established between the parties to the communication. As previously noted, examples of such block-cipher algorithms include AES, DES, and triple-DES. A forward cipher function under the key K applied to block X is designated as CIPH_{K}(X). An inverse cipher function under the key K applied to block X is designated as CIPH⁻¹_{K}(X). It should be noted that, in some operational modes, the forward cipher function CIPH_{K}(X) is used for both encryption and decryption.

A first basic mode described in NIST Special Publication 800-38A is electronic codebook (ECB) mode, which features, for a given key, the assignment of a fixed ciphertext block to each corresponding plaintext block, analogous to the assignment of code words in a codebook. ECB mode is specified in Equation (1) below:

ECB Encryption: Cⱼ=CIPH_{K}(Pⱼ) for j=1 . . . n (1.1)

ECB Decryption: Pⱼ=CIPI⁻¹_{K}(Cⱼ) for j=1 . . . n (1.2)

where Cⱼ is the jth ciphertext block of n ciphertext blocks, CIPH_{K}(Pⱼ) is a forward cipher function of the block-cipher algorithm under the key K applied to jth plaintext block Pⱼ of n plaintext blocks, and CIPH⁻¹_{K}(Cⱼ) is an inverse cipher function of the block-cipher algorithm under the key K applied to Cⱼ to produce Pⱼ. Note that, using the ECB mode, with a given key and cipher function, any given plaintext block gets encrypted to the same ciphertext block and vice versa.

A second basic mode described in NIST Special Publication 800-38A is the cipher block chaining (CBC) mode, which features the combining (i.e., chaining) of a given plaintext block with a previous ciphertext block. An initialization vector (IV) is needed for combination with the first plaintext block. The operation represented herein by the symbol ⊕ is an exclusive-OR (XOR) operation. The XOR operation is sometimes referred to as bitwise addition. As used herein, unless otherwise indicated, an addition operation refers to an XOR operation. The CBC mode is specified in Equation (2) below, where the terms are as defined above:

$$\begin{matrix}C B C Encryption \text{:} \begin{matrix}{C}_{1} = C I P {H}_{K} ( {P}_{1} ⊕ IV ) & \\ {C}_{j} = C I P {H}_{K} ( {P}_{j} ⊕ {C}_{j - 1} ) & for j = 2 … n\end{matrix} & \begin{matrix}( 2.1 ) \\ ( 2.2 )\end{matrix} \\ C B C Decryption \text{:} \begin{matrix}{P}_{1} = C I P {H}_{K}^{- 1} ( {C}_{1} ) ⊕ IV & \\ {P}_{j} = C I P {H}_{K}^{- 1} ( {C}_{j} ) ⊕ {C}_{j - 1} & for j = 2 … n\end{matrix} & \begin{matrix}( 2.3 ) \\ ( 2.4 )\end{matrix}\end{matrix}$$

As can be seen, in encryption, each successive plaintext block after the first is added to the previous output/ciphertext block to produce the new input block, and the forward cipher function is applied to each input block to produce the ciphertext block. In decryption, to recover any subsequent plaintext block after the first, the inverse cipher function is applied to the corresponding ciphertext block, and the resulting block is XORed with the previous ciphertext block

A third basic mode described in NIST Special Publication 800-38A is the Cipher Feedback (CFB) mode, which has an initialization vector as the initial input block and feeds back successive ciphertext segments into successive input blocks in the forward cipher to generate output blocks that are added to plaintext blocks to produce corresponding ciphertext blocks, and vice versa. The blocks of plaintext and ciphertext in CFB mode are b bits long; however, plaintext blocks are encrypted in segments of length s, where 1≦s≦b. The CFB mode is specified in Equation (3) below, where P^{#}ⱼ is the j^{th} plaintext segment, C^{#}ⱼ is the j^{th} ciphertext segment, Iⱼ is the j^{th} input block to the cipher function, Oⱼ is the j^{th} output block of the cipher function, C^{#}ⱼ is the j^{th} ciphertext segment (having a length s), LSBₓ(y) represents the x least-significant bits of y, MSBₓ(y) represents the x most-significant bits of y, and “∥” represents a concatenation operation. It should be noted that n in CFB mode represents the number of plaintext and/or ciphertext segments, which is not necessarily equal to the number of plaintext and/or ciphertext blocks.

$$\begin{matrix}C F B Encryption \text{:} \begin{matrix}{I}_{1} = IV & \\ {I}_{j} = L S {B}_{b - s} ( {I}_{j - 1} ) \vert \vert {C}_{j - 1}^{\#} & for j = 2 , … n \\ {O}_{j} = C I P {H}_{K} ( {I}_{j} ) & for j = 1 , 2 , … n \\ {C}_{j}^{\#} = {P}_{j}^{\#} ⊕ M S {B}_{s} ( {O}_{j} ) & for j = 1 , 2 , … n\end{matrix} & \begin{matrix}\begin{matrix}\begin{matrix}( 3.1 ) \\ ( 3.2 )\end{matrix} \\ ( 3.3 )\end{matrix} \\ ( 3.4 )\end{matrix} \\ C F B Decryption \text{:} \begin{matrix}{I}_{1} = IV & \\ {I}_{j} = L S {B}_{b - s} ( {I}_{j - 1} ) \vert \vert {C}_{j - 1}^{\#} & for j = 2 , … n \\ {O}_{j} = C I P {H}_{K} ( {I}_{j} ) & for j = 1 , 2 , … n \\ {P}_{j}^{\#} = {C}_{j}^{\#} ⊕ M S {B}_{s} ( {O}_{j} ) & for j = 1 , 2 , … n\end{matrix} & \begin{matrix}\begin{matrix}\begin{matrix}( 3.5 ) \\ ( 3.6 )\end{matrix} \\ ( 3.7 )\end{matrix} \\ ( 3.8 )\end{matrix}\end{matrix}$$

A fourth basic mode described in NIST Special Publication 800-38A is the Output Feedback (OFB) mode, which iterates the forward cipher function on an initialization vector (IV) to generate a sequence of output blocks that are added to plaintext blocks to produce corresponding ciphertext blocks, and vice versa. In OFB mode, the IV should be a nonce, i.e., the IV should be unique for each execution of the mode under the given key. In OFB encryption, the IV is processed by the forward cipher function to produce the first output block, which is added to the first plaintext block to produce the first ciphertext block. The first output block is then enciphered to produce the second output block, which is added to the second plaintext block to produce the second ciphertext block, and so on, i.e., output blocks of the forward cipher function are used as inputs to successive applications of the forward cipher function to produce new output blocks for adding to corresponding plaintext blocks. The OFB mode is specified in Equation (4) below, where P*ₙ represents the last block of the plaintext, which may be a partial block of u bits, and C*ₙ represents the last block of the ciphertext, which may be a partial block of u bits:

$$\begin{matrix}O F B Encryption \text{:} \begin{matrix}{I}_{1} = IV & \\ {I}_{j} = {O}_{j - 1} & for j = 2 , … n \\ {O}_{j} = C I P {H}_{K} ( {I}_{j} ) & for j = 1 , 2 , … n \\ {C}_{j} = {P}_{j} ⊕ {O}_{j} & for j = 1 , 2 , … n - 1 \\ {C}_{n}^{*} = {P}_{n}^{*} ⊕ M S {B}_{u} ( {O}_{n} ) & \end{matrix} & \begin{matrix}\begin{matrix}\begin{matrix}\begin{matrix}( 4.01 ) \\ ( 4.02 )\end{matrix} \\ ( 4.03 )\end{matrix} \\ ( 4.04 )\end{matrix} \\ ( 4.05 )\end{matrix} \\ O F B Decryption \text{:} \begin{matrix}{I}_{1} = IV & \\ {I}_{j} = {O}_{j - 1} & for j = 2 , … n \\ {O}_{j} = C I P {H}_{K} ( {I}_{j} ) & for j = 1 , 2 , … n \\ {P}_{j} = {C}_{j} ⊕ {O}_{j} & for j = 1 , 2 , … n - 1 \\ {P}_{n}^{*} = {C}_{n}^{*} ⊕ M S {B}_{u} ( {O}_{n} ) & \end{matrix} & \begin{matrix}\begin{matrix}\begin{matrix}\begin{matrix}( 4.06 ) \\ ( 4.07 )\end{matrix} \\ ( 4.08 )\end{matrix} \\ ( 4.09 )\end{matrix} \\ ( 4.10 )\end{matrix}\end{matrix}$$

A fifth basic mode described in NIST Special Publication 800-38A is the Counter (CTR) mode, which applies the forward cipher to a set of input blocks, called counters, to produce a sequence of output blocks that are added to plaintext blocks to produce corresponding ciphertext blocks, and vice versa. The counters should be unique for each message encrypted under a given key. One way to achieve this result is by starting with an initial input block and iteratively incrementing its value to get the subsequent counters. The forward cipher function is applied to each counter block, and the resulting output blocks are added to the corresponding plaintext blocks to produce the ciphertext blocks. The CTR mode is specified in Equation (5) below, where the j^{th} counter block is represented by Tⱼ:

$$\begin{matrix}C T R Encryption \text{:} \begin{matrix}{O}_{j} = C I P {H}_{K} ( {T}_{j} ) & for j = 1 , 2 , … n \\ {C}_{j} = {P}_{j} ⊕ {O}_{j} & for j = 1 , 2 , … n - 1 \\ {C}_{n}^{*} = {P}_{n}^{*} ⊕ M S {B}_{u} ( {O}_{n} ) & \end{matrix} & \begin{matrix}\begin{matrix}( 5.1 ) \\ ( 5.2 )\end{matrix} \\ ( 5.3 )\end{matrix} \\ C T R Decryption \text{:} \begin{matrix}{O}_{j} = C I P {H}_{K} ( {T}_{j} ) & for j = 1 , 2 , … n \\ {P}_{j} = {C}_{j} ⊕ {O}_{j} & for j = 1 , 2 , … n - 1 \\ {P}_{n}^{*} = {C}_{n}^{*} ⊕ M S {B}_{u} ( {O}_{n} ) & \end{matrix} & \begin{matrix}\begin{matrix}( 5.4 ) \\ ( 5.5 )\end{matrix} \\ ( 5.6 )\end{matrix}\end{matrix}$$

One block-cipher mode described in NIST Special Publication 800-38D is Galois/Counter Mode (GCM), which is a variation on the above-described CTR mode. GCM mode combines an encryption function referred to as GCTR and a hashing function referred to as GHASH. A device encrypting in GCM mode takes plaintext and Additional Authenticated Data (AAD) and outputs (1) a ciphertext based on the plaintext and (2) a hashed message digest, also called a tag, based on both the AAD and the ciphertext.

The GCTR encryption of plaintext string X, given key K and initial counter block ICB and resulting in ciphertext string Y (i.e., Y=GCTR_{K}(ICB, X)) is specified in Equation (6) below, where “┌x┐” represents the result of the application of the ceiling function to the number x, n is the number of blocks in plaintext string X, len(W) represents the bit-string length of bit string W (e.g., len(“01000101”)=8), int(W) is the integer for which the bit string W is a representation (e.g., int(“0100”)=4), “[x]ₛ” is an s-character bit-string representation of the integer x (e.g., [4]₈=“0000 0100”), CBᵢ is the i^{th} counter block, X*ₙ represents the last block of plaintext string X, which may be an incomplete block, and inc₃₂(W) represents the result of an incrementing function on bit string W, where inc₃₂(W)=MSB_{len(W)-32}(W)∥ [int([LSB₃₂(W))+1 mod 2³²]₃₂ (in other words, inc₃₂(W) increments the right-most 32 bits of bit string W by 1, with the result reduced modulo 2³²):

$$G C T R Encryption \text{:} \begin{matrix}n = ⌈ len ( X ) / 128 ⌉ & \\ {CB}_{1} = I C B & \\ {CB}_{i} = {inc}_{32} ( {CB}_{i - 1} ) & for i = 2 , 3 , … n \\ {Y}_{i} = {X}_{i} ⊕ C I P {H}_{K} ( {CB}_{i} ) & for i = 1 , 2 , … n - 1 \\ {Y}_{n}^{*} = {X}_{n}^{*} ⊕ M S {B}_{len ( {X}_{n}^{*} )} ( \begin{matrix}C I P {H}_{K} \\ ( {CB}_{n} )\end{matrix} ) & \\ Y = {Y}_{1} \vert \vert {Y}_{2} ‖ … ‖ {Y}_{n}^{*} & \end{matrix} \qquad \begin{matrix}\begin{matrix}\begin{matrix}\begin{matrix}\begin{matrix}( 6.1 ) \\ ( 6.2 )\end{matrix} \\ ( 6.3 )\end{matrix} \\ ( 6.4 )\end{matrix} \\ ( 6.5 )\end{matrix} \\ ( 6.6 )\end{matrix}$$

As can be seen, the GCTR mode is simply a variation of the above-described CTR mode where the specified counter-block incrementing method is the inc₃₂(W) function. The GCM mode of operation, given key K, initialization vector IV, plaintext P, and AAD A, which uses GCTR encryption and GHASH hashing, is specified in Equation (7) below, where t is a supported tag length associated with the key, J₀ is a pre-counter block generated from initialization vector IV, H is the hash subkey for the GHASH function, 0^{m} is an m-bit bit string of “0”s, u and v are integers, S is a text block, T is the resultant authentication tag, and C is the resultant ciphertext string:

$$G C M P rocessing \text{:} \begin{matrix}H = C I P {H}_{K} ( {0}^{128} ) \\ C = G C T {R}_{K} ( {inc}_{32} ( {J}_{0} ) , P ) \\ u = 128 \cdot ⌈ len ( C ) / 128 ⌉ - len ( C ) \\ v = 128 \cdot ⌈ len ( A ) / 128 ⌉ - len ( A ) \\ S = G H A S {H}_{H} ( {\begin{matrix}A ‖ {0}^{v} ‖ C ‖ {0}^{u} ‖ \\ {[ len ( A ) ]}_{64} \vert \vert [ len ( C ) ]\end{matrix}}_{64} ) \\ T = M S {B}_{t} ( G C T {R}_{K} ( {J}_{0} , S ) )\end{matrix} \qquad \begin{matrix}\begin{matrix}\begin{matrix}\begin{matrix}\begin{matrix}( 7.1 ) \\ ( 7.2 )\end{matrix} \\ ( 7.3 )\end{matrix} \\ ( 7.4 )\end{matrix} \\ ( 7.5 )\end{matrix} \\ ( 7.5 )\end{matrix}$$

One AES-based ciphering system described in the above-referenced IEEE P1619D5 publication is the LRW (named for Liskov, Rivest, and Wagner) transform. The LRW transform for the jth 128-bit plaintext block Pj of plaintext string P takes a 256-, 320-, or 384-bit key K and a 128-bit tweak value iⱼ. As noted below, key K is used as two keys: master key K1 and tweakable key K2. A tweak value is the name given in the LRW transform to a nonce. Typically, the tweak value is the sequential address or number of block P within string P.

The key K is used as two keys, namely K1 and K2, where K2 is the last 128 bits of key K and K1 is the first 128, 192, or 256 bits of key K. The LRW encryption and decryption modes of operation for the block P are specified in Equation (8), below, where TT, PP, and CC are temporary binary strings, C₁ is the resulting 128-bit ciphertext block, and [symbol] represents modular multiplication over the binary Galois field GF(2), modulo x¹²⁸+x⁷+x²+x+1.

$$\begin{matrix}L R W Encryption \text{:} \begin{matrix}TT = K 2 ( {i}_{j} ) \\ PP = {P}_{j} ⊕ TT \\ CC = C I P {H}_{K 1} ( PP ) \\ {C}_{j} = CC ⊕ TT\end{matrix} & \begin{matrix}\begin{matrix}\begin{matrix}( 8.1 ) \\ ( 8.2 )\end{matrix} \\ ( 8.3 )\end{matrix} \\ ( 8.4 )\end{matrix} \\ L R W Decryption \text{:} \begin{matrix}TT = K 2 ( {i}_{j} ) \\ CC = {C}_{j} ⊕ TT \\ PP = C I P {H}_{K 1}^{- 1} ( CC ) \\ {P}_{j} = PP ⊕ TT\end{matrix} & \begin{matrix}\begin{matrix}\begin{matrix}( 8.5 ) \\ ( 8.6 )\end{matrix} \\ ( 8.7 )\end{matrix} \\ ( 8.8 )\end{matrix}\end{matrix}$$

The LRW transform has a special operation for the last two blocks Pₘ₋₁ and Pₘ of plaintext string P whose bit length is not a multiple of 128, where the bit length of final block Pₘ is b bits. The encryption procedure, described in the above-referenced IEEE P1619D5 publication, involves (1) performing the LRW encryption transform on Pₘ₋₁ to get CC, (2) returning the first b bit of CC as Cₘ, (3) performing the LRW encryption transform on the concatenation of Pₘ and the last (128-b) bits of CC to get Cₘ₋₁. The corresponding LRW decryption procedure for the corresponding ciphertext blocks reverses this transformation.

As noted above, the XTS mode of operation is described in the IEEE Std 1619-2007 publication. The XTS encryption and decryption modes of operation for the jth block Pj of plaintext string P is specified in Equation (9) below, where α is a primitive element of Galois field GF(2¹²⁸), i is a tweak value typically corresponding to the logical block address of the first block of plaintext string P (but can also bee some other non-negative integer), and the other elements are as defined above.

$$\begin{matrix}X T S Encryption \text{:} \begin{matrix}TT = C I P {H}_{K 2} ( i ) {α}^{j} \\ PP = {P}_{j} ⊕ TT \\ CC = C I P {H}_{K 1} ( PP ) \\ {C}_{j} = CC ⊕ TT\end{matrix} & \begin{matrix}\begin{matrix}\begin{matrix}( 9.1 ) \\ ( 9.2 )\end{matrix} \\ ( 9.3 )\end{matrix} \\ ( 9.4 )\end{matrix} \\ X T S Decryption \text{:} \begin{matrix}TT = C I P {H}_{K 2} ( i ) {α}^{j} \\ CC = {C}_{j} ⊕ TT \\ PP = C I P {H}_{K 1}^{- 1} ( CC ) \\ {P}_{j} = PP ⊕ TT\end{matrix} & \begin{matrix}\begin{matrix}\begin{matrix}( 9.5 ) \\ ( 9.6 )\end{matrix} \\ ( 9.7 )\end{matrix} \\ ( 9.8 )\end{matrix}\end{matrix}$$

The XTS transform has a special operation for the last two blocks Pₘ₋₁ and Pₘ of plaintext string P, whose bit length is not a multiple of 128, where the bit length of final block Pₘ is b bits. This operation is referred to as ciphertext stealing. The encryption procedure, described in the above-referenced IEEE Std 1619-2007 publication, involves (1) performing the XTS encryption on Pₘ₋₁ to get CC, (2) returning the first b bit of CC as Cₘ, (3) performing the XTS encryption transform on the concatenation of Pₘ and the last (128-b) bits of CC to get Cₘ₋₁. The corresponding XTS decryption procedure for the corresponding ciphertext blocks reverses this transformation.

As described above, the CCM mode of operation combines counter (CTR) mode encryption with cipher block chaining message authentication code (CBC-MAC). A device encrypting in CCM mode takes a plaintext message M, additional authenticated data D, a nonce N, and a key K. An initial authentication block B₀ is generated from flags, the nonce N, and the length of message M in bytes (“l(M)”). 128-bit blocks B₁, . . . , Bₙ are formed from the additional authenticated data D and the plaintext message M. The authentication using CBC-MAC is performed as per Equation (10) below, where Xᵢ is the ith output block of the forward cipher function using key K, T is the unencrypted authentication tag, m is the size in bytes of the field for unencrypted authentication tag T, and first-m-bytes(W) is a function that returns the first m bytes of W:

$$C B C - M A C Authentication \text{:} \begin{matrix}{X}_{1} = C I P {H}_{K} ( {B}_{0} ) & \\ {X}_{i + 1} = C I P {H}_{K} ( {X}_{i} ⊕ {B}_{i} ) & for i = 1 , 2 , … , n \\ T = first \text{-} m \text{-} bytes ( {X}_{n + 1} ) & \end{matrix} \qquad \begin{matrix}\begin{matrix}( 10.1 ) \\ ( 10.2 )\end{matrix} \\ ( 10.3 )\end{matrix}$$

The message M and authentication tag T are then encrypted using CTR mode encryption. A key-stream of blocks Sᵢ is defined as Sᵢ=CIPH_{K}(Aᵢ) for i=0, 1, 2, . . . , where Aᵢ is a block comprising flags, the nonce N, and counter i. S₀ is used to generate encrypted authentication tag U, where U=T ⊕ first-m-bytes(S₀). The message M is then encrypted by performing an XOR operation on the bytes of message M with the first l(M) bytes of the concatenation of S₁, S₂, . . . . Note that S₀ is not used in the encryption of the message M.

A device decrypting in CCM mode takes ciphertext message C, additional authenticated data D, nonce N, and key K. The key-stream of blocks Sᵢ is generated as described above and used for adding to tag U and ciphertext message C to produce unencrypted tag T and plaintext message M. The corresponding CBC-MAC is then recomputed to generate T′, which is compared to T to authenticate plaintext message M and additional authenticated data D.

Novel systems and methods would be useful, which (1) allow greater flexibility with multiple operational modes and data streams and (2) do not require significant additional resources, such as integrated-circuit (IC) floor space in a hardware implementation.

### SUMMARY OF THE INVENTION

One embodiment of the invention can be a multi-mode cryptography (MM-C) module. The MM-C module is adapted to process an input string-data block using corresponding key data and corresponding mask data to generate an output string-data block. The MM-C module comprises (a) a data-stream (D-S) processing module adapted to process a corresponding input data block in accordance with the corresponding key data and corresponding mask data to generate an output data block, wherein the input data block is derived from at least one of the corresponding input string-data block and the corresponding mask data, (b) a key expansion and selection (E&S) module adapted to provide the corresponding key data to the D-S processing module, (c) a mask generation/updating (G/U) module adapted to provide the corresponding mask data to the D-S processing module, and (d) a controller adapted to control operations of the D-S processing module, the E&S module, and the G/U module such that the MM-C module processes, in an interleaved manner, a first data stream in a first cryptographic mode and a second data stream in a second cryptographic mode.

Another embodiment of the invention can be a multi-mode cryptography (MM-C) method for processing input string-data blocks using corresponding key data and corresponding mask data to generate output string-data blocks. The method comprises, for each corresponding input data block (a) providing the corresponding key data and the corresponding mask data and (b) processing the corresponding input data block in accordance with the corresponding key data and corresponding mask data to generate an output data block, wherein the input data block is derived from at least one of the corresponding input string-data block and the corresponding mask data. The method comprises processing, in an interleaved manner, a first data stream in a first cryptographic mode and a second data stream in a second cryptographic mode.

Yet another embodiment of the invention can be a storage controller comprising a multi-mode cryptography (MM-C) module. The MM-C module is adapted to process an input string-data block using corresponding key data and corresponding mask data to generate an output string-data block. The MM-C module comprises (a) a data-stream (D-S) processing module adapted to process a corresponding input data block in accordance with the corresponding key data and corresponding mask data to generate an output data block, wherein the input data block is derived from at least one of the corresponding input string-data block and the corresponding mask data, (b) a key expansion and selection (E&S) module adapted to provide the corresponding key data to the D-S processing module, (c) a mask generation/updating (G/U) module adapted to provide the corresponding mask data to the D-S processing module, and (d) a controller adapted to control operations of the D-S processing module, the E&S module, and the G/U module such that the MM-C module processes, in an interleaved manner, a first data stream in a first cryptographic mode and a second data stream in a second cryptographic mode.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a simplified block diagram of a storage controller in accordance with one embodiment of the present invention.

FIG. 2 shows a simplified block diagram of one embodiment of the multimode (MM) AES module of FIG. 1.

FIG. 3 shows a simplified block diagram of a hardware implementation of components of the MM-AES module of FIG. 2.

### DETAILED DESCRIPTION

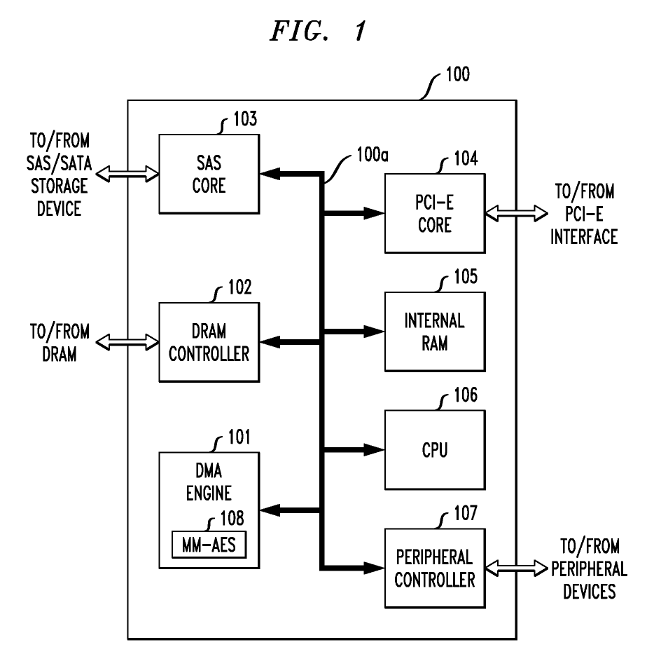

FIG. 1 shows a simplified block diagram of storage controller 100 in accordance with one embodiment of the present invention. Storage controller 100 is typically used in a computer system further comprising a CPU (central processing unit) (not shown) on a computer motherboard (not shown), one or more storage devices (not shown), RAM (random-access memory) (not shown), and optional peripheral devices (not shown). Storage controller 100 comprises direct memory access (DMA) engine 101, dynamic RAM (DRAM) controller 102, serial-attached-SCSI (small-computer-system interface) (SAS) core 103, PCI-E (peripheral component interface express) core 104, internal RAM (random access memory) module 105, storage-controller CPU 106, and peripheral controller 107, wherein these components of storage controller 100 are interconnected by data bus 100a.

DMA controllers generally coordinate data transfers between a computer system's storage devices and the computer system's memory or external devices. DMA engine 101 of storage controller 100 also provides encryption and decryption functionality for data stored in the one or more storage devices. DMA engine 101 comprises multimode AES module 108, which performs encryption and decryption of string data read from or written to the one or more storage devices. DRAM controller 102 interfaces with the computer-system DRAM. SAS core 103 interfaces with the one or more storage devices. PCI-E core 104 interfaces with the computer-system motherboard. Internal RAM 105 is for use by the components of storage controller 100. CPU 106 is the controller for the components of storage controller 100. Peripheral controller 107 interfaces with peripheral devices such as input/output (I/O) devices.

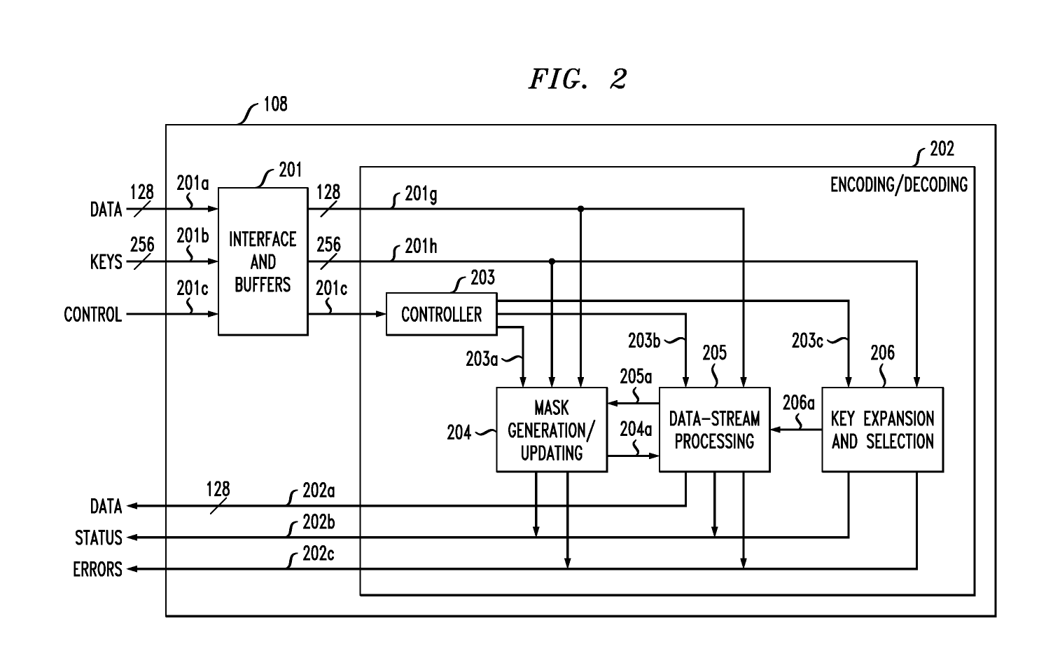

FIG. 2 shows a simplified block diagram of one embodiment of multimode AES (“MM-AES”) module 108 of FIG. 1. MM-AES module 108 receives and processes blocks of string data from multiple data streams. A block of string data may be a complete or incomplete block, where a complete block is, by present convention, 128 bits long. Typically, all blocks of a data stream other than the last one are complete blocks. The last block of a data stream may be complete or incomplete, depending on the processing mode and other factors. Some processing modes handle incomplete blocks by text “stealing,” as noted above. Some other processing modes handle incomplete blocks by padding them. Note that, unless otherwise indicated, as used herein, the term “string data” refers to plaintext or ciphertext, and string data is organized as a series of data blocks, each referred to as “string-data block.” In other words, the term “string-data block” refers to either a plaintext data block or a ciphertext data block.

After processing each block of a data stream, other than the final string-data block of the data stream, MM-AES module 108 generates or updates an internal state associated with the data stream, where the internal state is data-stream data needed to process the next string-data block of the data stream. Note that some processing modes, such as ECB mode, do not require an internal state and, therefore, (1) have empty internal states, (2) have no internal states, or (3) effectively ignore their internal states. MM-AES module 108 is thus able to process a first set of one or more blocks of a first data stream, then process one or more blocks of a second data stream, and then process a second set of one or more subsequent blocks of the first data stream, where data generated during the processing of the first set of blocks is saved and then used to process the second set of blocks. This is an example of interleaved processing.

MM-AES module 108 is capable of interleaved processing of up to eight different data streams. As noted above, interleaved processing allows MM-AES module 108 to, for example, begin processing a first data stream and then begin processing a second data stream before completing processing of the first data stream. Each data stream has (i) a corresponding AES operational mode, including selection between encryption and decryption, and (ii) a corresponding AES key. Note that the respective data streams may have different or the same operational modes, data streams, and/or keys. Many AES modes are also associated with a corresponding mask. As used herein, unless otherwise indicated, a mask for a data stream being processed using a particular AES mode refers to mode-specific intermediate information (e.g., the above-described internal state) needed to allow continuing processing of the data stream in accordance with the AES mode if processing is interrupted. Masks may include information such as, for example, counter blocks, previous output blocks, hash data, and/or length data. MM-AES module 108 is adapted to store up to eight masks and eight AES keys, each identifiable by a three-bit identifier.

Note that, in some AES modes, an internal state undergoes one or more transformations between the processing of two consecutive string-data blocks. For example, in CTR-mode encryption, the counter block used for a previous plaintext data block is incremented and enciphered before being added to a present plaintext data block to generate a present ciphertext output block. MM-AES module 108 increments the counter block as part of the processing of the previous block and stores the incremented counter block as the mask. When the present string-data block is processed, the mask is input to the forward AES function, and the result is added to the present string-data block to generate the ciphertext output block for the present string-data block. In general, MM-AES module performs mask pre-processing up to, but not including, AES forward/inverse ciphering. Thus, for example, in the XTS-mode processing of a previous string-data block, the previous string-data block's TT string block is multiplied by α to generate the present string-data block's TT string block, which is stored as the mask for use in processing a present string-data block. Note that, in alternative implementations of MM-AES module 108, different degrees of pre-processing may be performed between consecutive string-data blocks of a data stream.

MM-AES module 108 receives string-data blocks in series, with each string-data block accompanied by a corresponding key ID and mask ID. For a given data stream, the corresponding key is provided via key data path 201b concurrently with (i) the data stream's first data block (which, like all data blocks, is provided via path 201a) and (ii) the corresponding key ID, which is provided via control line 201c. Subsequent data blocks of that given stream are accompanied by the key ID, provided via control line 201c, but do not need the key itself. In other words, a data stream's key does not need to be provided more than once. Each received string-data block is separately processed based on its corresponding key and mask. Since different data streams may be interleaved, consecutively received string-data blocks may be part of the same data stream or of different data streams. For data streams where the processing of a subsequent string-data block depends on a result of processing of the previous string-data block (e.g., for CBC encryption), a corresponding mask is cached by MM-AES module 108 for future use by the subsequent data block of that same data stream. For data streams that require initialization vectors, those vectors are supplied as data blocks via data path 201a, with an appropriate corresponding control instruction on control line 201c. Any other required operational masks may be generated and updated internally and on the fly by MM-AES module 108 during processing of the corresponding data stream.

MM-AES module 108 comprises interface and buffers (“I&B”) module 201 and multimode AES encoding/decoding (“E/D”) module 202. I&B module 201 receives (1) string data, e.g., plaintext and ciphertext, via data path 201a, (2) keys via data path 201b, and (3) control instructions via control line 201c. I&B module 201 functions to synchronize and control the provision of these data, keys, and instructions to MM-AES E/D module 202. The control instructions received via control line 201c indicate, for example, whether the associated string data is to be encrypted or decrypted, which AES mode to use, and identify the data stream to which the particular string data belongs. I&B module 201 provides to MM-AES E/D module 202 (1) string data via data path 201g and (2) keys via data path 201h. I&B module 201 also passes through the control instructions on control line 201c. In addition, I&B module 201 caches keys for use by MM-AES E/D module 202.

MM-AES E/D module 202 outputs (1) processed, i.e., encrypted or decrypted, string data via data path 202a, (2) status flags, such as module state, key status, and mask status, via data path 202b, and (3) any error flags via data path 202c. Authentication tags, when their provision is necessary, are provided via data path 202a, with an appropriate corresponding indicator status flag (e.g., “tag_valid”) on data path 202b. It should be noted that individual data paths may represent, in varied physical implementations, discrete, independent data buses or portions of shared data buses. Data paths 201a, 201g, and 202a are 128-bit buses able to accommodate all the bits of a single entire AES data block in parallel. Data paths 201b and 201h are 256-bit buses able to accommodate all the bits of an entire AES key (whether 128-, 196-, or 256-bit) in parallel. Note that some compound keys, such as key K in LRW mode, which comprises K1 and K2, may be provided as two separate keys.

MM-AES E/D module 202 comprises controller 203, mask generation/updating (“G/U”) module 204, data-stream (D-S) processing module 205, and key expansion and selection (“E&S”) module 206. Controller 203 receives control signal 201c and outputs control signals 203a, 203b, and 203c to mask G/U module 204, D-S processing module 205, and key E&S module 206, respectively. Modules 204, 205, and 206 output (1) stream status flags via data path 202b and (2) error flags via data path 202c.

Key expansion and selection module 206 receives keys via data path 201h and provides the expanded and selected keys to data-stream processing module 205 via data path 206a. D-S processing module 205 also receives string data via data path 201g and outputs processed string data via data path 202a. D-S processing module 205 may provide data, such as processed string data, to mask generation/updating module 204 via path 205a and may receive data (e.g., masks for processing data, initialization vectors, and string data) from mask G/U module 204 via data path 204a. Note that initialization vectors may either be generated by, or simply passed through by, mask G/U module 204 for provision to D-S processing module 205. Mask G/U module 204 may receive string data via data path 201g and may receive keys via key path 201h.

Controller 203 controls the operation of the other modules of MM-AES E/D module 202 via control lines 203a, 203b, and 203c so that appropriate processing is performed on the input string data and corresponding keys. Controller 203 includes a finite state machine (FSM) for the control of modules 204, 205, and 206 and the operation flow of E/D module 202. Mask G/U module 204 handles the masks by, for example, (i) performing Galois-field multiplications and other operations to generate or update masks, (ii) storing masks for the various data streams being processed by MM-AES module 108, and (iii) storing initialization vectors (“IVs”) when needed. Note that mask G/U module 204 may also store and/or pass through to D-S processing module 205 input string data or other data. D-S processing module 205 performs the mode-specific AES encrypting and decrypting (e.g., by performing the forward or inverse AES cipher function) using (i) the input string-data block, the mask, and/or IV and (ii) the expanded key provided by key E&S module 206. Note that, depending on the processing mode, the AES cipher function may be applied to either the input string-data block or the corresponding mask.

Key E&S module 206 synchronously expands the key corresponding to an input string-data block and provides the appropriate corresponding key data for the AES-round processing performed by D-S processing module 205. In other words, for each round of performing the AES cipher function, key E&S module 206 provides the appropriate segment of the expanded key schedule to D-S processing module 205. Since each input string-data block is received with a corresponding key and is not necessarily preceded in processing by a string-data block from the same data stream, key E&S module 206 dynamically performs this expansion and provision for each input string-data block.

As noted above, MM-AES module 108 processes each received input string-data block individually. Each string-data block received via path 201a is accompanied by (a) the corresponding key on path 201b and (b) the corresponding instructions indicating processing mode on control line 201c. This allows MM-AES module 108 to process multiple data streams where the different streams use different keys (including keys of different lengths) and/or different processing modes (including selecting encryption or decryption). It should be noted that MM-AES module 108 may receive commands via control line 201c without corresponding data blocks on path 201a. Also, as indicated elsewhere herein, data blocks other than input string-data blocks may be received on path 201a. Similarly, as indicated elsewhere herein, data blocks other than output string-data blocks may be output on path 202a.

Mask generation/updating module 204 stores a mask for each particular stream requiring a mask so that, if MM-AES module 108 returns to processing that stream, then mask G/U has available the prior mask for processing the next string-data block. MM-AES module 108 can also be updated to properly process (e.g., encrypt or decrypt) string-data blocks in accordance with new AES or other modes of operation not described above, including future modes of operation not yet invented.

Note that one optional mode of processing is transparent processing, also called bypassing, where data blocks are pipelined through MM-AES module 108 without encryption or decryption. Transparent mode may be used to simplify processing of a sequence of mixed data blocks having blocks that do not require encryption/decryption by avoiding both (i) extracting data blocks out of the sequence and (ii) creating bypass mechanisms. Transparent mode may also be used to implement non-encrypting authentication protocols, such as the IEEE media access control (“MAC”) security (MACsec) protocol, described in the IEEE 802.1AE Standard, incorporated herein by reference in its entirety.

Storage controller 100 of FIG. 1 may concurrently process more interleaved streams than the eight that MM-AES module 108 is adapted to process. Generally, for a data stream processed by MM-AES module 108, the corresponding mask stored by MM-AES module 108 is sufficient information for proper processing of a subsequent string-data block of that data stream. Supposing MM-AES is concurrently processing eight data streams (i.e., processing at full capacity), MM-AES module 108 may nevertheless add additional data streams to the interleaved processing by externally storing masks. Storage controller 100 may store a mask for a first data stream outside of mask G/U module 204 of MM-AES module 108, thereby freeing up MM-AES module 108 to process another data stream. MM-AES module 108 can return to processing the first stream by reading the externally stored mask back into mask G/U module 204 and associating it with a corresponding mask ID, which does not have to be the same as the first data stream's previously associated mask ID. This technique allows storage controller 100 to concurrently process more data streams than MM-AES module 108 may be able to concurrently process on its own.

The ability of MM-AES module 108 to externally store and read masks also provides added flexibility to operational modes, such as XTS-AES, that use ciphertext-stealing to encrypt or decrypt data streams whose respective final blocks are not the standard length (e.g., 128 bits). As explained above, ciphertext stealing uses joint processing of the final two blocks of the data stream for encryption and decryption. MM-AES module 108 may store one of the final processed blocks in mask G/U module 204. Alternatively, MM-AES module 108 may store one of the final pair of processed blocks in the above-described external storage space of storage controller 100.

Table 1, below, shows exemplary processing commands for XTS-mode AES encryption of four separate consecutive string-data blocks of a single data stream. Note that, as described above, XTS (like LRW mode) uses a key K that comprises two independently used keys, K1 and K2, where K2 is used to encrypt the tweak and K1 is used to encrypt an intermediate block resulting from the addition of an input string-data block and a corresponding mask.

TABLE 1

| Command | Explanation |
|---|---|
| Save_Key K_ID 1 | Save_Key is a key-loading command, |
| Key_Type 1 | where (a) the integer (here, 1) after K_ID |
| Key=0xNNN₁ | identifies the key by key-storage location |
| | where it is to be stored, (b) the integer after |
| | Key_Type (here, 1) identifies the type of |
| | key (e.g., 128-bit, 256-bit, “backward” 128- |
| | bit, “backward” 256-bit, etc., where so- |
| | called “backward” keys are used for |
| | decryption), and (c) 0xNNN₁ represents |
| | some hexadecimal number, which is the |
| | value of the key to be stored in key-storage |
| | location 1. |
| Save_Key K_ID 0 | Same as above, but here, the hexadecimal |
| Key_Type 1 | number 0xNNN₂ is stored in key-storage |
| Key=0xNNN₂ | location 0. |
| Make_Mask K_ID 0 T_ID 1 | Make_Mask is a mask-calculating |
| Data=0xNNN₃ | instruction, where (a) the integer (here, 0) |
| | after K_ID identifies the key-storage |
| | location for the key for use in the mask |
| | calculation, (b) the integer (here, 1) after |
| | T_ID indicates the mask-storage location |
| | for storing the resultant mask, and (c) |
| | 0xNNN₃ represents the 128-bit tweak (here |
| | corresponding to the logical block address |
| | of the first data block of the data stream) |
| | with the key K_ID 0 to generate the mask. |
| Encrypt K_ID 1 | Encrypt is an AES-processing command to |
| T_ID 1 | encrypt hexadecimal string-data block |
| Data=0xNNN₄ | 0xNNN₄ using (a) the encryption key stored |
| | at key-storage location 1 (as indicated by |
| | K_ID 1) and (b) the mask at mask-storage |
| | location 1 (indicated by T_ID 1). Note that |
| | particular mask storage locations may be |
| | reserved for particular processing modes. |
| | Note further that a particular T_ID argument, |
| | e.g., 0, may be used to indicate that no mask |
| | is to be used (e.g., for ECB mode). The |
| | encryption also updates the mask at T_ID 1, |
| | by Galois-field multiplying the current |
| | mask with α (in other words, Tⱼ₊₁ = Tⱼ [symbol] α). |
| Encrypt K_ID 1 | Same as above, but for input string-data |
| T_ID 1 | block 0xNNN₅ |
| Data=0xNNN₅ | |
| Encrypt K_ID 1 | Same as above, but for input string-data |
| T_ID 1 | block 0xNNN₆ |
| Data=0xNNN₆ | |
| Encrypt K_ID 1 | Same as above, but for input string-data |
| T_ID 1 | block 0xNNN₇ |
| Data=0xNNN₇ | |

Table 2, below, shows exemplary processing commands for GCM-mode AES encryption of 3 blocks of input data. Note that the final block may be incomplete.

TABLE 2

| Command | Explanation |
|---|---|
| GCM_Save_Key K_ID 2 | GCM_Save_Key is a key-loading |
| Key_Type 1 Key=0xNNN₈ | command for GCM mode, where the |
| | key, of type 1, to be stored in key-storage |
| | location 2 is hexadecimal number |
| | 0xNNN₈. |
| GCM_Init_H T_ID 2 | GCM_Init_H invokes calculation of hash |
| Data=0xNNN₉ | subkey H, which encrypts a 128-bit zero |
| | block using the key at K_ID 2. Data |
| | block 0xNNN₉ (1) may be the zero block |
| | used in calculating H or (2) may be |
| | ignored since the zero block may be |
| | internally generated. The calculated |
| | value of hash subkey H is then stored in |
| | mask location T_ID 2 of mask G/U |
| | module 204 for use as needed. |
| GCM_Load_IV T_ID 3 | GCM_Load_IV is an initialization- |
| Data=0xNNN₁₀ | vector-loading command that loads IV |
| | 0xNNN₁₀ and stores it in mask G/U |
| | module 204. IV 0xNNN₁₀ is used to |
| | generate counting block J₀, which is |
| | stored in mask location T_ID 3 of mask |
| | G/U module 204. |
| GCM_Load_Len | GCM_Load_Len is a parameter-loading |
| Data=PacketLen | command to save the lengths, in bits, of |
| | both the AAD and the plaintext stream |
| | for GCM processing. The parameters are |
| | saved in mask G/U module 204. |
| GCM_AAD Data=0xNNN₁₁ | GCM_AAD is a data-loading command |
| | for uploading 0xNNN₁₁ as a block of |
| | additional authenticated data (AAD) for |
| | calculating the tag in GCM mode. The |
| | AAD data is passed through to the output |
| | (if that option is selected). |
| GCM_AAD Data=0xNNN₁₂ | Same as above, but this AAD data block |
| | is 0xNNN₁₂ |
| GCM_AAD Data=0xNNN₁₃ | Same as above, but this AAD data block |
| | is 0xNNN₁₃ |
| GCM_Encrypt K_ID 2 T_ID 3 | GCM_Encrypt is an AES-processing |
| Data=0xNNN₁₄ | command to encrypt hexadecimal string- |
| | data block 0xNNN₁₄ using GCM mode |
| | and the previously uploaded parameters. |
| | The encryption round increments the |
| | value of the counting block at mask |
| | location T_ID 3. |
| GCM_Encrypt K_ID 2 T_ID 3 | Same as above, but for plaintext data |
| Data=0xNNN₁₅ | block 0xNNN₁₅ |
| GCM_Encrypt K_ID 2 T_ID 3 | Same as above, but for plaintext data |
| Data=0xNNN₁₆ | block 0xNNN₁₆ |
| GCM_Tag | GCM_Tag is a tag-output command to |
| | output the calculated GCM tag for the |
| | input plaintext and AAD. |

Data blocks and corresponding keys are processed in parallel data pipelines by MM-AES module 108. The particular way that an implementation of MM-AES module 108 is configured may determine the average number of clock cycles that MM-AES module 108 will require to process a data block. For a hardware implementation, there are typically trade-offs between processing speed and circuit size. A larger circuit, as in a fully-unrolled implementation, would generally be able to start processing an entire incoming string-data block every single clock cycle. In other words, while the pipeline is full, the fully-unrolled implementation processes 14 blocks at a time, each block in a different stage of processing.

Unrolling is a hardware-implementation technique for adding hardware components to allow for faster average processing through pipelining. As would be appreciated by one of ordinary skill in the art, various degrees of unrolling are possible in implementing a device in hardware, where less unrolling saves integrated-circuit (IC) floor space at the expense of processing speed and more unrolling increases processing speed at the expense of greater IC floor space. Meanwhile, a smaller circuit with no unrolling may process a single data block at a time, i.e., without concurrently processing other data blocks. Intermediate-level circuits, such as a half-unrolled implementation, may take up less floor space than the larger fully-unrolled circuit and require fewer clock cycles on average per data block than the smaller not-unrolled circuit.

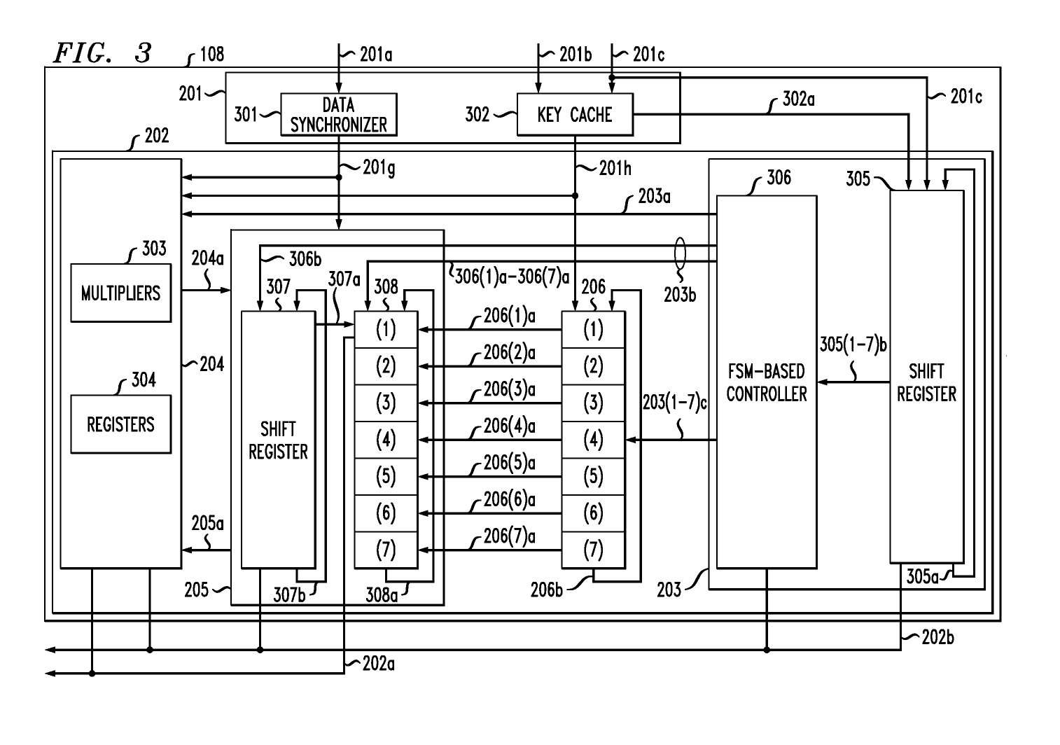

FIG. 3 shows a simplified block diagram of a hardware implementation of components of MM-AES module 108 of FIG. 2. MM-AES module 108 utilizes a half-unrolled architecture for controller 203, data-stream (D-S) processing module 205, and key E&S module 206. The half-unrolled architecture allows MM-AES module 108 to process a data block in two rotations along the main data-processing path, as explained in more detail below. MM-AES module 108 uses a pipelined architecture to process up to seven data blocks simultaneously. Each data block travels through the processing pipeline along with corresponding instructions, expanded AES key, and other needed corresponding data, which travel in parallel pipelines.

Each of the various pipelines comprises seven linearly connected segments to correspond with the seven linearly connected segments of the main data-processing path. As used herein, when referring to a plurality of segments, the term “linearly connected” refers to a plurality of segments that forms a pipeline and includes a first segment, a last segment, and zero or more intermediate segments, where (i) the first segment is connected to a subsequent segment, (ii) the last segment is connected to a preceding segment, and (iii) each intermediate segment is connected to both a preceding segment and a subsequent segment. Note that additional connections between segments (e.g., feedback connections) are possible. Along with the preliminary AddRoundKey( ) operation, a data block begins its transformation, e.g., round one of the AES transformation, in the first segment of the data-processing path. The data block then proceeds through segments 2 to 7, e.g., the second to seventh rounds. After segment 7, the processed block is fed back to the first segment for further processing, e.g., the eighth round. Note that, therefore, segment 1 is adapted to receive both (a) new input data blocks and (b) feedback data blocks, but only one for further processing in any particular clock cycle. Depending on the AES key used, an input data block may be fully processed in 10, 12, or 14 rounds. It should be noted that, in some AES modes, additional operations, such as XOR operations, may be performed after the AES round transformations are completed but before providing an output block via path 202a.

I&B module 201 of MM-AES module 108 comprises data synchronizer 301 and key-cache module 302. Data synchronizer 301 comprises a plurality of registers that cache the data provided on data path 201a for timely (i.e., synchronous) provision to E/D module 202 via data path 201g along with the corresponding command instructions provided to controller 203 via control path 201c. Key-cache module 302 stores up to eight AES keys corresponding to the up-to-eight data streams that may be concurrently processed by MM-AES module 108. Key-cache module 302 provides information about the lengths of its cached keys to controller 203 via path 302a. Controller 203 uses the key-length information in its control of key E&S module 206 and other modules.

Mask G/U module 204 comprises multipliers module 303 and registers module 304. Multipliers module 303 performs binary Galois-field multiplications for generating and updating masks (e.g., in XTS, LRW, and GCM modes). Registers module 304 caches the generated and/or updated masks and provides them, as needed, to data-stream processing module 205. Registers module 304 may also store initialization vectors (IVs) for processing modes that use IVs (e.g., CBC and CTR modes).

Controller 203 comprises shift register 305 and FSM-based controller 306, which are parallel pipelines to the processing pipelines of data-stream processing module 205 and key E&S module 206. Shift register 305 comprises seven segments (not shown) and is used to synchronize commands and related information with their corresponding data blocks as those data blocks are processed through the data-processing pipeline of data-stream processing module 205. When needed, command and related information blocks are looped from the last segment of shift register 305 to the first segment of shift register 305 via feedback path 305a. Controller 306 comprises seven segments (not shown), each of which (1) receives commands and related data from a corresponding segment of shift register 305, (2) controls corresponding segments in data-stream processing module 205 and key E&S module 206 based on those received commands and related data. Each segment of controller 306 accesses a block's set of commands and related information from a corresponding segment of register 305 via path 305b, which comprises paths 305(1)b-305(7)b. Controller 306 may provide feedback to shift register 305 via a feedback path (not shown). Control path 203c to key E&S module 206 comprises seven paths 203(1)c-203(7)c, each going from a segment of controller 306 to a corresponding segment of key E&S module 206. Control path 203b to data-stream processing module 205 comprises constituent control lines 306(1)a-306(7)a and 306b.

Since there may be certain operations that need to be performed only once for a data block (including, e.g., feedback operations resulting from the half-unrolled architecture) or only once for an entire data stream, the first segment of controller 306 may be dedicated to orchestrate those operations, along with the regular AES-round operations that the other six segments perform, while the other six segments of controller 306 only perform the regular AES-round operations. Alternative embodiments may have several or all of the segments of controller 306 capable of orchestrating any operations of mask G/U module 204, data-stream processing module 205, and/or key E&S module 206.

Key E&S module 206 comprises seven segments, 206(1)-206(7), which together form a parallel pipeline to the main data-processing pipeline of data-stream processing module 205. The pipelines are generally implemented as 128-bit wide pathways comprising interconnected logic gates (including latches and/or flip-flops) transforming the data as it goes from segment to segment. Key E&S module 206 receives an AES key from key cache 302 via path 201h and then performs key expansions synchronously for each round of AES processing of the corresponding data block. The appropriate segment of the dynamically expanded key schedule is provided to a corresponding segment in data-stream processing module 205 via one of paths 206(1)a-206(7)a. While a data block is being processed, the corresponding AES-key data moves from one segment of key E&S module 206 to the next with each round, looping, when needed, from segment 206(7) to segment 206(1) via path 206b.

Data-stream processing module 205 comprises shift register 307 and main data-processing block 308. Shift register 307 comprises seven segments (not shown) and functions as a parallel pipeline of auxiliary data corresponding to data blocks in main data-processing block 308 for keeping the corresponding auxiliary data with the data block for use as needed (e.g., for XOR operations before and/or after AES processing of the data block). Depending on the processing mode for a particular string-data block, the string-data block may be (i) processed via main data-processing block 308 with mask data as auxiliary data moving in parallel in shift register 307 or (ii) moving, as the auxiliary data, in shift register 307 in parallel with the processing of the corresponding mask data in main data-processing block 308. Auxiliary data for processing the corresponding string-data block is provided by shift register 307 via path 307a to segment 308(1) of main data-processing block 308. Shift register 307 is controlled by controller 306 via path 306b. When needed, auxiliary-data blocks are looped from segment 7 of shift register 307 to segment 1 of shift register 307 via path 307b.

Data-processing block 308 is the main pipelined data path for encrypting or decrypting data blocks and comprises seven segments, each controlled by controller 306 via one of 306(1)a-306(7)a. The topmost segment, segment 308(1), receives either a new input block from I&B module 201 via path 201g or a fed-back partly-processed data block from segment 308(7) via path 308a. Each segment comprises the hardware circuitry for performing the transformations of one round of the AES algorithm, encryption or decryption, on the received data block, using the corresponding key segment in key E&S module 206 and command segment in controller 306. Each segment 308(i) is adapted to perform one round of a cipher-function transformation on a transitory data block. As used here, the term “transitory block” refers to the state of a data block in any round of a cipher-function transformation. Note that, depending on control instructions from controller 203, a segment 308(i) may simply pass through a transitory data block without transforming the transitory data block.

Segment 308(1) additionally comprises circuitry for performing (1) preliminary-round processing, (2) first-round processing, (3) last-round processing, (4) and auxiliary-data processing, whether before or after the rounds of AES processing. Segment 308(1) is adapted to both start processing a new input data block and finish processing a fed-back processed data block for output via path 202a. Note that, in alternative implementations, different and/or additional segments of data-processing block may be adapted to perform auxiliary-data processing and/or output the output block via path 202a.

An embodiment of the invention has been described where MM-AES module 108 of FIG. 2 is capable of interleaved processing of up to eight different data streams using independent modes. Alternative embodiments of the invention have an MM-AES module that is capable of interleaved processing of a different number of data streams by making adjustments that would be known to a person of ordinary skill in the art. In one alternative embodiment, the MM-AES module is capable of processing multiples data streams but using only one AES mode of operation. In yet another alternative embodiment, the MM-AES module is capable of processing only one data stream at a time. In these alternative embodiments, there may be modifications and simplifications to the control commands to take advantage of the simplified processing options.

An embodiment of the invention has been described where MM-AES module 108 of FIG. 2 is adapted to store the AES keys for the interleaved data streams being processed, where string-data blocks (other than the first) of a particular stream (i) are received with a corresponding key ID indicating which stored AES key to use and (ii) are not received with the AES key itself. In an alternative embodiment, no key ID is used, and each string-data block is received with a corresponding AES key. In yet another alternative embodiment, each string-data block is received with both an AES key and a key ID. In yet another alternative embodiment, a combination of the described systems is used, where a block may be received with a corresponding key, a corresponding key ID, or both.

An implementation of MM-AES module 108 of FIG. 2 has been described with particular data paths between modules. As would be appreciated by one of ordinary skill in the art, the data paths are representational and can be implemented as, for example and without limitation, dedicated conductors directly connecting components or shared bus-like connections interconnecting several components. In general, the connections are pathways for information including data and commands. Additionally, particular implementations may have more, fewer, and/or otherwise-different connections than described herein.

An implementation of MM-AES module 108 of FIG. 2 has been described with a half-unrolled architecture comprising a seven-segment pipeline. Alternative implementations have partially unrolled implementations having different degrees of unrolling, with corresponding modifications to the components of MM-AES module 108, which would be understood by one of ordinary skill in the art.

An embodiment of the invention has been described wherein for each string-data block processed by MM-AES module 108 of FIG. 2, the corresponding AES key is expanded. In one alternative implementation, key E&S module 206 is adapted to cache the latest expanded key schedule so that, if I&B module 201 determines that the next string-data block is from the same data stream and, therefore, corresponds to the same AES key, then key E&S module 206 may use the cached expanded key schedule and skip the step of expanding the next-received corresponding AES key.

An embodiment of the invention has been described as comprising an MM-AES module. The invention is not limited to systems using AES. Alternative embodiments use different symmetric block ciphers such as, for example, DES and triple-DES. The generic term multimode cryptography (MM-C) module is used to refer to modules embodying the invention regardless of the particular symmetric block cipher used.

Unless indicated otherwise, the term “determine” and its variants as used herein refer to obtaining a value through measurement and, if necessary, transformation. For example, to determine an electrical-current value, one may measure a voltage across a current-sense resistor, and then multiply the measured voltage by an appropriate value to obtain the electrical-current value. If the voltage passes through a voltage divider or other voltage-modifying components, then appropriate transformations can be made to the measured voltage to account for the voltage modifications of such components and to obtain the corresponding electrical-current value.

As used herein in reference to data transfers between entities in the same device, and unless otherwise specified, the terms “receive” and its variants can refer to receipt of the actual data, or the receipt of one or more pointers to the actual data, wherein the receiving entity can access the actual data using the one or more pointers.

Exemplary embodiments have been described wherein particular entities (a.k.a. modules) perform particular functions. However, the particular functions may be performed by any suitable entity and are not restricted to being performed by the particular entities named in the exemplary embodiments.

Exemplary embodiments have been described with data flows between entities in particular directions. Such data flows do not preclude data flows in the reverse direction on the same path or on alternative paths that have not been shown or described. Paths that have been drawn as bidirectional do not have to be used to pass data in both directions.

As used herein, the term “cache” and its variants refer to a dynamic computer memory that is preferably (i) high-speed and (ii) adapted to have its present contents repeatedly overwritten with new data. To cache particular data, an entity can have a copy of that data stored in a determined location, or the entity can be made aware of the memory location where a copy of that data is already stored. Freeing a section of cached memory allows that section to be overwritten, making that section available for subsequent writing, but does not require erasing or changing the contents of that section.

References herein to the verb “to generate” and its variants in reference to information or data do not necessarily require the creation and/or storage of new instances of that information. The generation of information could be accomplished by identifying an accessible location of that information. The generation of information could also be accomplished by having an algorithm for obtaining that information from accessible other information.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

The present invention may be implemented as circuit-based processes, including possible implementation as a single integrated circuit (such as an ASIC or an FPGA), a multi-chip module, a single card, or a multi-card circuit pack. As would be apparent to one skilled in the art, various functions of circuit elements may also be implemented as processing steps in a software program. Such software may be employed in, for example, a digital signal processor, micro-controller, or general-purpose computer.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other non-transitory machine-readable storage medium, wherein, when the program code is loaded into and executed by a machine, such as a computer, the machine becomes an apparatus for practicing the invention. The present invention can also be embodied in the form of program code, for example, stored in a non-transitory machine-readable storage medium including being loaded into and/or executed by a machine, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless explicitly stated otherwise, each numerical value and range should be interpreted as being approximate as if the word “about” or “approximately” preceded the value of the value or range. As used in this application, unless otherwise explicitly indicated, the term “connected” is intended to cover both direct and indirect connections between elements.

For purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. The terms “directly coupled,” “directly connected,” etc., imply that the connected elements are either contiguous or connected via a conductor for the transferred energy.

The use of figure numbers and/or figure reference labels in the claims is intended to identify one or more possible embodiments of the claimed subject matter in order to facilitate the interpretation of the claims. Such use is not to be construed as limiting the scope of those claims to the embodiments shown in the corresponding figures.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

Although the steps in the following method claims are recited in a particular sequence with corresponding labeling, unless the claim recitations otherwise imply a particular sequence for implementing some or all of those steps, those steps are not necessarily intended to be limited to being implemented in that particular sequence.

We claim:

1. A multi-mode cryptography (MM-C) module, wherein:
the MM-C module is adapted to process an input string-data block using corresponding key data and corresponding mask data to generate an output string-data block; and
the MM-C module comprises:
a data-stream (D-S) processing module adapted to process a corresponding input data block in accordance with the corresponding key data and corresponding mask data to generate an output data block, wherein the input data block is derived from at least one of the corresponding input string-data block and the corresponding mask data;
a key expansion and selection (E&S) module adapted to provide the corresponding key data to the D-S processing module;
a mask generation/updating (G/U) module adapted to provide the corresponding mask data to the D-S processing module; and
a controller adapted to control operations of the D-S processing module, the E&S module, and the G/U module such that the MM-C module processes, in an interleaved manner, a first data stream in a first cryptographic mode and a second data stream in a second cryptographic mode.

2. The MM-C module of claim 1, wherein the first cryptographic mode is different from the second cryptographic mode.

3. The MM-C module of claim 1, wherein, for the interleaved processing:
(1) the MM-C module processes a first set of one or more string-data blocks of the first data stream and stores first mask data generated from the processing of the first set;
(2) the MM-C module then processes one or more string-data blocks of the second data stream; and
(3) the MM-C module then processes a second set of one or more string-data blocks of the first data stream using the stored first mask data to process the second set.

4. The MM-C module of claim 1, wherein:
the MM-C module is a multi-mode advanced encryption standard (MM-AES) module; and
each of the first and second cryptography modes is an AES operational mode.

5. The MM-C module of claim 1, wherein the MM-C module enables any of (i) electronic codebook (ECB) mode, (ii) cipher block chaining (CBC) mode, (iii) cipher feedback (CFB) mode, (iv) output feedback (OFB) mode, (v) counter (CTR) mode, (vi) Galois/counter (GCM) mode, (vii) Liskov, Rivest, and Wagner (LRW) mode, (viii), XOR-Encrypt-XOR-based tweaked codebook mode with ciphertext stealing (XTS) mode, and (ix) counter-mode encryption with cipher-block-chaining message-authentication-code (CCM) mode to be selected for each of the first and second cryptographic modes.

6. The MM-C module of claim 5, wherein:
the first cryptographic mode is the ECB mode; and
the D-S processing module does not use mask data for the processing of the first data stream.

7. The MM-C module of claim 1, wherein the MM-C module is adapted to process, in an interleaved manner with at least one of the first and second data streams, a third data stream in a transparent mode, wherein, for each string-data block of the third data stream, the D-S processing module is adapted to generate an output data block identical to the string-data block.

8. The MM-C module of claim 1, wherein:
the D-S processing module is adapted to process the input data block by performing one of (i) a forward cipher function based on the key data and (ii) an inverse cipher function based on the key data; and
the input string-data block is part of one of (i) the first data stream and (ii) the second data steam.

9. The MM-C module of claim 1, wherein:
the controller is adapted to receive a corresponding set of control instructions for each input string-data block of the first and second data streams received by the MM-C module;
each input string-data block corresponds to an input data block processed by the D-S processing module; and
the control instructions for each input string-data block indicate (i) a corresponding cryptographic mode, (ii) encryption or decryption processing, and (ii) the corresponding key and mask data to be used by the D-S processing module in processing the corresponding input data block.

10. The MM-C module of claim 1, wherein the key data for an input data block corresponds to an expanded key schedule derived from a cryptographic key for the data stream of the corresponding input string-data block.

11. The MM-C module of claim 10, wherein:
the MM-C module is adapted to initially:
receive the cryptographic key for the data stream along with (i) an input string-data block of the data stream and (ii) a corresponding cryptographic-key identifier (key ID); and
cache the cryptographic key; and
the MM-C module is further adapted to subsequently:
receive input string-data blocks of the data stream along with the corresponding key ID and without the cryptographic key; and
provide the cached cryptographic key that corresponds to the key ID to the key E&S module.

12. The MM-C module of claim 1, further adapted to:
store mask data corresponding to the first data stream in a memory external to the MM-C module; and
retrieve the externally stored mask data for processing an input string-data block of the first data stream.

13. The MM-C module of claim 1, wherein the MM-C module further comprises an interface and buffers (I&B) module adapted to:
receive a cryptographic key and a corresponding cryptographic-key identifier (key ID);
cache the cryptographic key;
associate the cached cryptographic key with the corresponding key ID; and
respond to receipt of an input string-data block and a corresponding key ID by synchronously providing both (i) the cached cryptographic key corresponding to the key ID to the key E&S module and (ii) the input string-data block to at least one of the D-S processing module and the mask G/U module.

14. The MM-C module of claim 1, wherein:
the D-S processing module comprises a main data-processing block, which is a partially unrolled pipeline comprising e linearly connected data-processing segments, each adapted to perform cipher-function transformation of a transitory data block;
the key data for an input data block corresponds to an expanded key schedule derived by the key E&S module from a cryptographic key for the data stream of the corresponding input string-data block;
the key E&S module is a partially unrolled pipeline comprising e key-provision segments;
each key-provision segment is connected to a corresponding data-processing segment of the main data-processing block;
each key-provision segment is adapted to generate an appropriate segment of the expanded key schedule for provision to the corresponding data-processing segment; and
the controller comprises a finite state machine (FSM) comprising e control segments, each connected to control (i) a corresponding data-processing segment of the D-S processing module and (ii) the corresponding key-provision segment of the key E&S module so that the corresponding data-processing segment performs the transfer-function transformation of the transitory data block using the appropriate segment of the expanded key schedule.

15. The MM-C module of claim 14, wherein:
the D-S processing module further comprises a shift-register pipeline for shifting auxiliary data synchronously with corresponding transitory data blocks in the main data-processing block; and
the auxiliary data is derived from at least one of the corresponding input string-data block and the corresponding mask data.

16. The MM-C module of claim 14, wherein:
the controller further comprises a shift-register pipeline comprising e shift-register segments, each connected to a corresponding control segment of the FSM for controlling the corresponding data-processing and key-provision segments;
the shift-register pipeline comprises a first shift-register segment adapted to receive a corresponding set of control instructions for each input string-data block received by the MM-C module;
the shift-register pipeline is adapted to shift the control instructions synchronously with the corresponding data block in the main data-processing block; and
the control instructions for each input string-data block indicate (i) a corresponding cryptographic mode, (ii) encryption or decryption processing, and (ii) the corresponding key and mask data to be used by the D-S processing module in processing the corresponding input data block.

17. The MM-C module of claim 14, wherein:
the main data-processing block includes a feed-back path from data-processing segment e to a first data-processing segment for providing the processed transitory data block from data-processing segment e to the first data-processing segment;
the first data-processing segment is adapted to receive auxiliary data;
the first data-processing segment is adapted to receive and transform the input data block; and
the first data-processing segment is adapted to provide the output string-data block.

18. A multi-mode cryptography (MM-C) method for processing input string-data blocks using corresponding key data and corresponding mask data to generate output string-data blocks, wherein:
the method comprises, for each corresponding input data block:
(a) providing the corresponding key data and the corresponding mask data; and
(b) processing the corresponding input data block in accordance with the corresponding key data and corresponding mask data to generate an output data block, wherein the input data block is derived from at least one of the corresponding input string-data block and the corresponding mask data; and
the method comprises processing, in an interleaved manner, a first data stream in a first cryptographic mode and a second data stream in a second cryptographic mode.

19. A storage controller comprising a multi-mode cryptography (MM-C) module, wherein:
the MM-C module is adapted to process an input string-data block using corresponding key data and corresponding mask data to generate an output string-data block; and
the MM-C module comprises:
a data-stream (D-S) processing module adapted to process a corresponding input data block in accordance with the corresponding key data and corresponding mask data to generate an output data block, wherein the input data block is derived from at least one of the corresponding input string-data block and the corresponding mask data;
a key expansion and selection (E&S) module adapted to provide the corresponding key data to the D-S processing module;
a mask generation/updating (G/U) module adapted to provide the corresponding mask data to the D-S processing module; and
a controller adapted to control operations of the D-S processing module, the E&S module, and the G/U module such that the MM-C module processes, in an interleaved manner, a first data stream in a first cryptographic mode and a second data stream in a second cryptographic mode.
